(19) United States
(12) Patent Application Publication
(10) Pub. No.: US 2025/0051585 A1
(43) Pub. Date: Feb. 13, 2025

(54) Method For Applying A Polymer Sublayer For Reinforcing The Mechanical Resistance, In Particular To Heat, Of Fluorinated Coatings

(71) Applicant: SEB S.A., Ecully (FR)

(72) Inventor: Barbara Gantillon, Ecully Cedex (FR)

(73) Assignee: SEB S.A., Ecully (FR)

(21) Appl. No.: 18/720,073

(22) PCT Filed: Dec. 16, 2022
(86) PCT No.: PCT/FR2022/052409

§ 371 Date: Jun. 14, 2024

(30) Foreign Application Priority Data
Dec. 16, 2021 (FR) FR2113662

(51) Int. Cl. C09D 5/16; C09D 5/00; C09D 7/45; C09D 7/61; C09D 127/18; C09D 171/00; C09D 181/06

(52) U.S. Cl. CPC C09D 5/1693; C09D 5/002; C09D 5/1668; C09D 7/45; C09D 7/61; C09D 127/18; C09D 171/00; C09D 181/06

(57) ABSTRACT

A method for applying a release coating to a metal support includes the following steps: i. depositing on the metal support one or more continuous layers of a tie sublayer comprising one or more polymers selected from the group consisting of polyaryletherketones (PAEK), polyethyleneimines (PEI), polyimides (PI), polyamide imides (PAI) and polybenzymidazoles (PBI) in an amount of 20% to 95% by weight of the total weight of said sublayer, characterized in that it comprises only a single sintering step at T° C.>400° C., and that of the total, after the deposition of the various layers.

The invention applies in the field of non-stick coatings for cooking surfaces of culinary articles and electrical cooking appliances.

Culinary items coated in PTFE (polytetrafluoroethylene) are popular on the market because they allow cooking that requires little or no added fat and are easy of maintenance. However, an inherent weakness of these coatings is their low mechanical resistance, particularly when hot.

To overcome this, numerous technical solutions have been proposed which consist of reinforcing the coating with hard fillers or by the interposition of hard sublayers of inorganic or organic type.

In the case of primers reinforced with hard organic or inorganic fillers, significant improvements in abrasion resistance are actually observed but impacts on the metal when cooking foods such as pork ribs or when using metal spatulas are also observed.

In the case of hard inorganic bases such as, for example, those made from enamel or else metal oxides, the resistance to abrasion is further improved and the problem of impacts is limited without, however, being eliminated.

Organic polymer sublayers are also known. These sublayers actually allow to considerably reduce the appearance of the scratch or even eliminate it. This strategy is therefore very interesting. The polymers used are very often thermoplastics with high thermal resistance and a high melting point such as for example polyaryletherketone and in particular oxy-1,4-phenylenephenylene-oxy-1,4-phenylene-carbonyl-1,4-phenylene or PEEK or else phenylene sulfides.

The PEEK polymer is interesting in culinary articles since it has a high melting point (343° C.) and excellent thermal stability under conditions of use at 260° C.

The following coating techniques can be carried out to obtain a sublayer from this type of polymer: spray coating, roller coating, curtain coating, pad printing, screen printing, thermal projection, electrostatic spraying, inkjet.

In application WO 2000/54895, the use of a sublayer composed only of PEEK (with particle sizes comprised between 5 μm and 100 μm, and with a d50 preferably of 20 μm) deposited on a metal substrate, with a coverage comprised between 60% to 95% of the surface of the article then covered with a mono- or multi-layer non-stick coating, based on fluoro resins and fluoro copolymers. The PEEK sublayer is deposited either by pad printing or screen printing, or by spray in the form of a dispersion.

The thickness of this PEEK layer is comprised between 5 μm and 100 μm.

The disadvantage of the method as described is that it requires double baking of the fluorinated coating based on PEEK. The first cooking requires a temperature higher than the melting point of the polymer making up the sublayer (that is to say between 38° and 400° C. for PEEK) in order to allow its adhesion to the metal substrate. The article must then be cooled significantly, which is very costly in terms of time and energy, but essential in order to be able to apply the successive fluorinated layers which will be sintered during a second baking at high temperature (>420° C.).

In application WO 2010/130954, a hard sublayer forming a continuous network, deposited discontinuously on the interior bottom of the culinary article, is described. The material making up this layer is a ceramic (alumina-titanium mixture) or a metal or a polymer (PAI, PEI, PI, PES, PPS, PEK or PEEK). The surface of the culinary article covered by this material is comprised between 30% to 80% and the dimension between the drops deposited is comprised between 2 μm to 50 μm. The surface of this hard layer has a roughness with a Ra of 2 μm to 12 μm, preferably 4 μm to 8 μm.

This material is sprayed by a flame spray method in powder form with a particle size preferably comprised between 20 μm and 45 μm.

It is necessary to strongly preheat the metal substrate before deposition of the powders by spray flame above 180° C.

The fluorinated layers are then deposited by spray coating once the deposition has cooled to room temperature. A single sintering at 430° C. is then carried out.

In patent FR 2871038, the use of a PEEK sublayer is mentioned, with a PAI resin and fluorinated resins deposited on a metal substrate then covered with a non-stick coating in one or more layers and without the presence of PEEK in these upper layers.

The sublayer is composed of a mixture of PAI, PEEK and PTFE such that the PTFE is comprised between 9 to 15%/w and the PAI resin is comprised between 4 to 5%/w.

In all cases the level of PEEK in dry matter in the final fluorinated film is of the order of 0.12% to 1.1%/w, preferably 0.12% to 0.9%/w.

PEEK powder has a particle size D50 of 5 to 35 μm.

In all cases, the first coating layer contains fluoride resins.

This liquid coating is deposited by spray. Upper layers of fluorinated coatings also containing one or more primers are then deposited by spray. The sintering of all these layers is carried out in a single baking of 400 to 420° C.

The disadvantage of this application method is that the level of PEEK resin in the first layer is very low and does not achieve sufficient mechanical performance to have an anti-scratch coating.

In application WO 00/054896, the use of a PEEK sublayer without fluorinated resin consisting of at least 50% by weight of PEEK powder is mentioned, so that the surface covered in PEEK is comprised between 60% to 95% of the surface of the article.

This primer which contains at least 50% PEEK, may also contain a mixture with other pure or mixed thermostable resins such as polyphenylene sulphide (PPS), polyetherimide (PEI), polyimide (PI), polyetherketone (PEK), polyethersulfone (PES), polyamideimide (PAI).

It can also contain fillers selected from metal oxides: silica, mica, or lamellar fillers. It does not include any fluoride resin.

The first cooking is carried out at a high temperature of at least 260° C., preferably greater than or equal to 340° C. to melt the PEEK.

PEEK is in powder form with a particle size comprised between 4 μm and 80 μm, with a d50 preferably of 20 μm. The thickness of this sublayer is comprised between 5 μm and 100 μm.

This liquid coating is deposited by spray. Upper layers of fluorinated coatings or even primers with fluorinated topcoats are then deposited by spray. The sintering of all these layers is carried out in a second baking to sinter the fluorinated coating, between 400° C. to 420° C.

In U.S. Pat. No. 6,596,380 B1, mention is made of an anti-scratch fluorinated coating the first layer of which contains at least 50% by weight of PEEK (preferably between 60% and 95%), mixed with a thermostable polymer resin such as PPS, PEI, PI, PAI and mixtures thereof and fillers such as metal oxides, silica, micas, and in the absence of any fluorinated resin. This first layer has a thickness comprised between 5 and 100 μm.

PEEK is a powder with a particle size of 4 μm to 80 μm with a d50 of around 20 μm. However, the method for obtaining such a coating necessarily involves double baking/sintering between 40° and 420° C.

### Definitions

The expression “culinary article”, must be understood, within the meaning of the present invention, as an object intended for cooking. Culinary articles within the meaning of the present invention comprise objects intended to be heated to cook or reheat food carried by the cooking element or contained in the cooking element and electrical cooking appliances.

The expression “object intended to be heated to cook or reheat the food carried by the cooking element or contained in the cooking element”, must be understood, within the meaning of the present invention, as an object which will be heated by an external heating system, such as a cooking hearth, and which is capable of transmitting the heat energy provided by this external heating system to a material or food in contact with said object. Such an object may in particular be a frying pan, a pot, a sauté pan, a pan or pot for fondue or raclette, a stewpot, a wok, a sauté pan, a crepe maker, a cooking pot, a casserole dish, a culinary mold.

The expression “electric cooking appliance”, must be understood, within the meaning of the present invention, as an object intended for cooking, configured to produce heat.

The expression “object configured to produce heat”, within the meaning of the present invention, must be understood as a heating object having its own heating system.

Such an object may in particular be a grill, a plancha, a cooker or bread machine tank, an electric crepe maker, an electric raclette appliance, an electric fondue appliance, an electric grill, an electric plancha, an electric cooker, a bread machine.

### SUMMARY OF THE INVENTION

This invention describes the manufacture of a culinary article resistant to cold and hot scratches while being a non-stick article.

To overcome all these problems, the inventors have identified an optimal method for applying a tie sublayer and upper fluorinated layers comprising a single sintering step under standard conditions, which makes the method industrializable without additional investment.

The upper fluorinated layers are applied by spray, obtaining excellent non-stick of the coating. The presence of reinforcing fillers (alumina, silicon carbide, etc.) is also possible in the fluorinated layers. The coating obtained is produced with a single sintering condition at 420-430° C. Excellent anti-scratch performance is obtained while maintaining the cost of the coating at industrially acceptable prices.

This type of coating allows to significantly increase the scratch resistance of the coating both at room temperature and at high temperature (180° C.) while minimizing method costs and maintaining excellent non-stick and adhesion properties.

A first object of the invention relates to a method for applying a non-stick coating to a metal support comprising the following steps:
i. Depositing on the metal support one or more continuous layers of a tie sublayer comprising one or more polymers selected from the group consisting of polyaryletherketones (PAEK), polyethyleneimines (PEI), polyimides (PI), polyamide imides (PAI) and polybenzymidazole (PBI) in an amount of 20 to 95% by weight of the total weight of said sublayer,
characterized in that the method in overall comprises only a single sintering step at T° C.>400° C., after the deposition of the various layers.

A second object of the invention relates to a method for manufacturing a culinary article (1) characterized by the following steps:
i. A step of providing a metal support (2), comprising two opposite faces,
ii. A step of shaping said support (2) to give it the shape of a cap, which comprises a bottom (211) and a side wall (212) rising from the bottom (211), and thus define a concave internal face (21) adapted to receive food and a convex external face (22), said step ii) being carried out either before step iv) of producing the tie sublayer (3), or after step v) of producing the non-stick coating,
iii. Optionally, a step of treating the internal face (21) of the support (2), to obtain a treated internal face favoring the adhesion of a sublayer (3) on the support (2)
iv. Depositing, on the internal face (21) of the support (2), one or more continuous layers of the tie sublayer (3) as defined in claims 1 to 10,
v. Optionally depositing one or more layers of a non-stick coating based on fluorocarbon resins, preferably two layers, on said tie sublayer (3) deposited in step (iv), characterized in that the method in overall comprises only a single sintering step (vi) at T° C.>400° C., after the deposition of the various layers.

### DETAILED DESCRIPTION

A first object of the invention relates to a method for applying a non-stick coating to a metal support comprising the following steps:
i. Depositing on the metal support one or more continuous layers of a tie sublayer comprising one or more polymers selected from the group consisting of polyaryletherketones (PAEK), polyethyleneimines (PEI), polyimides (PI), polyamide imides (PAI) and polybenzymidazole (PBI) in an amount of 20 to 95% by weight of the total weight of said sublayer,
characterized in that it comprises in overall only a single sintering step at T° C.>400° C., after the deposition of the various layers.

The method according to the invention does not comprise two sintering steps or two cooking steps. The method according to the invention does not comprise three sintering steps or three cooking steps. The method according to the invention comprises a single step of cooking by sintering.

Advantageously, the method of the invention comprises the following step after step i. before the sintering step:
ii. Depositing one or more layers of a non-stick coating based on one or more fluorocarbon resin(s), preferably two layers.

Advantageously, said tie sublayer comprises one or more aromatic polymer resins selected from the group consisting of phenylene polysulfides (PPS) and polyethersulfones (PES), preferably from polyethersulfones (PES).

Advantageously, the polyaryletherketone(s) (PAEK) is (are) selected from the group consisting of: polyetherketones (PEK), polyetheretherketones (PEEK), polyetherketoneketones (PEKK), polyetheretherketoneketones (PEEKK) and polyetherketoneetherketoneketones (PEKEKK), particularly preferably is (are) PEEK.

Advantageously, the polymer(s) is (are) selected from the group consisting of polyarylether ketones (PAEK) and polyamide imides (PAI) and mixtures thereof.

Advantageously, the polymer(s) is (are) selected from the group consisting of polyetheretherketones (PEEK) and polyamide imides (PAI) and mixtures thereof. Advantageously, said tie sublayer comprises one or more fluorocarbon resin(s).

Advantageously, the fluorocarbon resin(s) present in the tie sublayer or in at least one of the other layers of the non-stick coating is/are selected from the group consisting of: polytetrafluoroethylene (PTFE), the copolymer of tetrafluoroethylene and perfluoropropylvinyl ether (PFA), the copolymer of tetrafluoroethylene and hexafluoropropylene (FEP) and mixtures thereof, particularly preferably comprise PTFE.

Advantageously, the fluorocarbon or acrylic resin(s) represent from 0 to 30%, preferably from 0 to 15%, preferably 0 to 5%, more preferably 0 to 4%, particularly preferably from 0 to 3%, by weight of the total weight of the sublayer.

In a particular embodiment, the tie sublayer does not comprise any fluorocarbon resin(s), in particular no PTFE.

Advantageously, said tie sublayer further comprises inorganic reinforcing fillers, preferably selected from the group consisting of metal oxides, carbides, nitrides, preferably alumina, silicon carbides or fumed silica.

Advantageously, said tie sublayer further comprises one or more solvents, which are preferably polar aprotic, preferably unlabeled, for example N-formylmorpholine (NFM), N-Methyl Imidazole (NMI), N-ButylPyrrolidone (NBP), dimethyl sulfoxide (DMSO), or alcoholic solvents, for example Propylene Glycol (PPG), Diethylene glycol.

Advantageously, said tie sublayer further comprises one or more surfactants.

Advantageously, said tie sublayer further comprises one or more anti-foam agents.

Advantageously, said tie sublayer further comprises one or more pigments.

Advantageously, the thickness of said tie sublayer is comprised between 10 and 100 μm, preferably between 20 and 80 μm, more preferably between 30 and 60 μm.

According to one embodiment, said tie sublayer comprises:
a) between 20% and 80% by weight of the total weight of the sublayer of one or more polymers selected from the group consisting of polyaryletherketones (PAEK), polyethyleneimines (PEI), polyimides (PI), polyamide imides (PAI) and polybenzymidazoles (PBI), with a weight ratio PAEK:(PEI+PI+PAI+PBI) of between 1:1 and 15:1,
b) at least 20%, preferably at least 25%, by weight of the total weight of the sublayer of one or more polymers selected from the group consisting of phenylene polysulfides (PPS) and polyethersulfones (PES),
c) less than 40%, preferably less than 30%, by weight of the total weight of the sublayer of reinforcing inorganic fillers, preferably between 5 and 25% by weight,
d) optionally one or more fluorocarbon or acrylic resins,
e) optionally one or more pigments.

Advantageously, when the polymers a) represent 20 to 40% of the sublayer according to the invention, the weight ratio PAEK:(PEI+PI+PAI+PBI) is comprised between 6:1 and 12:1. Advantageously, when the polymers a) represent 40 to 80% of the sublayer according to the invention, the PAEK:(PEI+PI+PAI+PBI) weight ratio is comprised between 12:1 and 15:1.

Advantageously, the polymers b) represent 25 to 40% by weight of the total weight of the sublayer, preferably 25 to 35%.

The weight ratio between polymers a) and polymers b) is advantageously between 2:5 and 2:3, preferably between 1:2 and 1:3.

Advantageously, the pigment(s) e) represent less than 30%, preferably less than 20%, by weight of the total weight of the sublayer.

Advantageously, the polymer(s) (b) is (are) polyethersulfone(s) (PES).

In a preferred embodiment of the invention, parts (a) and (b) are a mixture consisting of PEEK, PAI and PES polymers.

According to another embodiment, said tie sublayer comprises:
a) between 20% and 80% by weight of the total weight of the sublayer of one or more polymers selected from the group consisting of polyaryletherketones (PAEK),
b) less than 20%, preferably less than 10% by weight of the total weight of the sublayer of one or more pigments,
c) one or more fluorocarbon resin(s), preferably more than 25% by weight of the total weight of the sublayer.

Advantageously, said tie sublayer consists of:
a) between 20% and 80% by weight of the total weight of the sublayer of one or more polymers selected from the group consisting of polyaryletherketones (PAEK),
b) less than 20%, preferably less than 10% by weight of the total weight of the sublayer of one or more pigments,
c) one or more fluorocarbon resin(s), preferably more than 25% by weight of the total weight of the sublayer.

Advantageously, said tie sublayer comprises:
a) more than 50% by weight, preferably more than 60% by weight of the total weight of the sublayer of one or more polymer(s) selected from the group consisting of polyaryletherketones (PAEK), preferably PEEK,
b) less than 10% by weight of the total weight of the sublayer of one or more pigments,
c) between 20% and 40% by weight, preferably between 30% and 40% by weight, of the total weight of the sublayer of one or more fluorocarbon resin(s), preferably PTFE or a PTFE/PFA mixture.

Advantageously, said tie sublayer consists of:
a) more than 50% by weight, preferably more than 60% by weight of the total weight of the sublayer of one or more polymer(s) selected from the group consisting of polyaryletherketones (PAEK), preferably PEEK,
b) less than 10% by weight of the total weight of the sublayer of one or more pigments,
c) between 20% and 40% by weight, preferably between 30% and 40% by weight, of the total weight of the sublayer of one or more fluorocarbon resin(s), preferably PTFE or a PTFE/PFA mixture.

Advantageously, said tie sublayer consists of:
a) more than 50% by weight, preferably more than 60% by weight of the total weight of the sublayer of one or more polymer(s) selected from the group consisting of polyaryletherketones (PAEK), preferably PEEK,
b) between 20% and 40% by weight, preferably between 30% and 40% by weight, of the total weight of the sublayer of one or more fluorocarbon resin(s), preferably PTFE or a PTFE/PFA mixture.

The acrylic resin(s) is/are advantageously selected from the group consisting of: polymers resulting from an emulsion polymerization of different monomers with other acrylic-based monomers.

The organic or inorganic pigment(s) is/are selected from the group consisting of pigment powders known to the person skilled in the art in the field, for example titanium dioxide, carbon black, graphite, certain thermochromic pigments such as bismuth oxide, vanadium oxide or else organic perylene pigments.

In a preferred embodiment of the invention, the tie sublayer according to the invention is a mixture consisting of PEEK, PAI, PES, PTFE and optionally fillers, acrylic resins and pigments.

Advantageously, said metal support is the cap of a culinary article and said coating is applied to the surface in contact with the food.

Advantageously, said culinary article is a frying pan, a wok or a pot.

Advantageously, said metal support is a mono-layer support made of aluminum or aluminum alloy, cast aluminum, stainless steel, cast steel or copper, or a multi-layer support comprising from the outside to the inside the following layers ferritic stainless steel/aluminum/austenitic stainless steel or stainless steel/aluminum/copper/aluminum/austenitic stainless steel, or a foundry aluminum cap, aluminum or aluminum alloys lined with a stainless steel exterior base.

Said metal support (disk or shaped article) on which the tie sublayer according to the invention is applied may have a roughness obtained by sandblasting, shot blasting, stamping, brushing or chemical attack.

Advantageously, said tie sublayer is deposited by spray, by coating, by screen printing or by roller.

Advantageously, the sintering temperature is comprised between 400° C. and 440° C.

A second object of the invention relates to a method for manufacturing a culinary article (1) characterized by the following steps:
i. A step of providing a metal support (2), comprising two opposite faces,
ii. A step of shaping said support (2) to give it the shape of a cap, which comprises a bottom (211) and a side wall (212) rising from the bottom (211), and thus define a concave internal face (21) adapted to receive food and a convex external face (22), said step ii) being carried out either before step iv) of producing the tie sublayer (3), or after step v) of producing the non-stick coating,
iii. Optionally, a step of treating the internal face (21) of the support (2), to obtain a treated internal face favoring the adhesion of a sublayer (3) on the support (2)
iv. Depositing, on the internal face (21) of the support (2), one or more continuous layers of the tie sublayer (3) according to the invention,
v. Optionally depositing one or more layers of a non-stick coating based on fluorocarbon resins, preferably two layers, on said tie sublayer (3) deposited in step (iv), characterized in that it comprises in overall only a single sintering step (vi) at T° C.>400° C., after the deposition of the various layers.

Advantageously the metal support (2) of step i. is in disk shape.

### FIGURES

FIG. 1 shows a photograph of the HOT BLADE test. 3 rotating metal tips on the coating of the interior side of the culinary article which is placed on a heat source.

FIG. 2 shows a schematic view of a culinary article according to the invention.

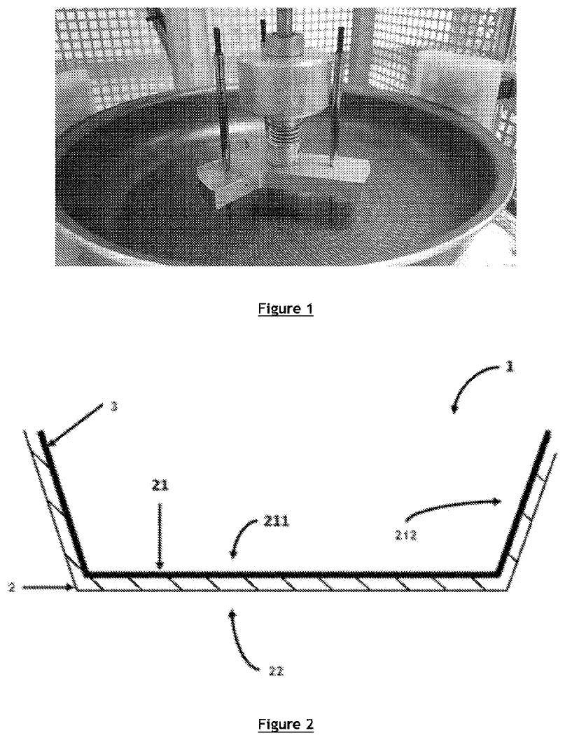

### EXAMPLES

### 1) Performance Tests Carried Out on the Coatings

### Mechanical Durability Evaluation Tests-Scratch Resistance

The excellent mechanical performance of this coating is evaluated using the hot blade test.

This test method evaluates the scratch resistance of a coating using a mobile system composed of 3 hard tips (ballpoint pens). This test also known as “tiger paw” induces a rotation around its axis and describes an epicyclic movement on the coated surface. The test is carried out under heat. The degradation of the coating (appearance of spots on the metal, scratches, delamination of the coating) is evaluated visually after different time cycles.

Non-stick tests with carbonized milk are carried out after each of the previous cycles.

This test ultimately allows three output data to be evaluated:
Delamination of the fluorinated coating on a metallic surface or fluorinated inter-layers after a test time (duration).
The appearance of the scratch on the metal: Scratch on the metal after a test time (duration).
Loss of non-stick (AA=0) at a test time (duration).

### Evaluation of the Corrosion Resistance of a Layer of Semi-Finished or Primer on a Shot-Blasted Aluminum Substrate

Regarding point 3, above, there is a test.

The corrosion resistance of a non-stick coating on a sandblasted aluminum substrate is evaluated, by evaluating its resistance to the diffusion of salt towards the corroding metal substrate.

For this purpose, we proceed as follows:
the substrate coated with the fluorinated coating is immersed for 20 hours in an aqueous saline solution brought to a boil. This saline solution contains 10% by weight of sodium chloride. The protocol for this test is that defined in the AFNOR NF D21-511 § 3.3.5 standard,
at the end of each immersion, a visual inspection of the final appearance of the coating is carried out, which consists of noting the presence or absence of traces of corrosion (by visual observation with the naked eye or with a binocular magnifying glass). In practice, this involves detecting the possible presence of traces such as blisters with extended areas, white traces under the coating,
this observation is followed by a grid test according to the ISO 2409 standard.

### Evaluation of the Adhesion of a Layer of Semi-Finished or Primer on a Smooth Aluminum Substrate

There is a standardized grid test according to the ISO 2409 standard, followed by immersion of the coated article for 18 hours (consisting of an alternation of 3 cycles of 3 hours in boiling water and 3 cycles of 3 hours in oil at 200° C.). Then, it is observed whether or not the non-stick coating shows detachment.

The rating is as follows: no square must be detached to obtain a rating of 100 (excellent adhesion); in the event of detachment, the value recorded is equal to the rating of 100 reduced by the number of detached squares

### 2) Exemplary Embodiments

### Supports:

Sandblasted or shot-blasted aluminum supports then passed through a suitable surface treatment to eliminate organic contaminants.

### Raw Materials

Heterocyclic polymer resins:
   PolyAmide-Imide (PAI) resin with 29% dry extract in N-butylpyrrolidone (NBP),
   Resin in powder form: PolyAcide amic at 90% dry extract in N-methylpyrrolidone (NMP/Water), reference from SOLVAY, grade TORLON AI10LS,
   Resin in solvent: 9% polybenzimidazole (PBI) in dimethylacetamide (DMAc).
Other aromatic polymer resins:
   PolyEtherEtherKetone (PEEK) powder resin, Vicote 704 from VICTREX, polymer powder with a d50 of 10 μm,
   PEKK powder resin, KEPSTAN 7002 PT from Arkema with a d50 of 20 μm,
   PEKK powder resin, KEPSTAN 6002 PT from Arkema with a d50 of 50 μm,
   Aqueous phase dispersion of VICTREX, mass composition grade Vicote F815: PEEK/[PTFE+PFA]: 70/30% and 30% in aqueous phase,
   PolyEtherSulfone (PES) powder resin, micronized grade from SOLVAY, polymer powder with a d50 of 40 μm.
Fluorinated polymer resins (to be predispersed at 20% in PPG with UltraTurrax, 20 000 rpm)
   PTFE powder from 3M/DYNEON: TF 9207 Z,
   FEP powder from 3M/DYNEON: 6233PZ.
Unlabeled polar aprotic solvents (that is to say non-toxic within the meaning of the present invention):
   N-formylmorpholine (NFM),
   N-Methyl Imidazole (NMI),
   N-ButylPyrrolidone (NBP).
Alcohol solvent
   Propylene Glycol: PPG,
   Diethylene glycol: butyl diglycol.
Surfactant and anti-foam agent
   Tego foamex K7 from Evonik,
   Genapol X089 from Clariant.
Reinforcing fillers:
   Alumina, grade CAHP-F240 (particle size in d50: 50 μm),
   Silicon carbide, grades SIKA 400, SIKA 320,
   Pyrogenic silica,
   MICA MILL200/325.
Pigment:
   Black 100,
   Blue CM13,
   Perylene brick red (wear indicator),
   Titanium,
   Talc,
   Graphite
Acrylic resin:
   Modarez PW336: 30% acrylic polymer solution in aqueous phase,
   Rohagit SD 15: 30% acrylic polymer solution in aqueous phase.

### Example 1

On a shaped aluminum disk (30 cm in diameter), previously degreased and sanded to obtain a roughness of 4 to 7 μm (Ra), a continuous layer SCD1 (SCD=tie sublayer) of the example 1 as described below.

### Principle of Operation of the Jar Mill (Mechanical Milling)

### Principle

Ball milling consists of loading a jar with the sample to be milled and so-called milling balls and rotating the jar around its axis at a certain speed. The rotation of the jar is generally carried out using a roller machine. The sample can be milled in dry form or dispersed in a suitable solvent (for example in water, in alcohol or in a solvent). The dispersion may also contain certain adjuvants (such as a dispersant or anti-foam agent).

Preparation of an aqueous semi-finished composition SF1 based on a heterocyclic polymer with an amine and unlabeled polar aprotic solvent.

An aqueous semi-finished composition SF1 is produced including the following compounds, their respective amounts being indicated below:

| | | |
|---|---|---|
| PAI resin with 29% dry extract in NBP | 327.9 | g |
| NBP | 117.7 | g |
| Triethylamine | 32.8 | g |
| Demineralized Water | 521.6 | g |
| TOTAL | 1000.0 | g |

The implementation of the PAI includes a step of transition to the aqueous phase via obtaining a polyamide-amic acid salt. This step is carried out in a ball mill of the brand Discontimill®, at room temperature in the presence of amine.

The properties of the aqueous composition SF1 thus obtained are as follows:
Theoretical dry extract: 9.5%
Dry extract measured in the composition: 9.3%

Preparation of a semi-finished composition SF2 carried out in a ball mill for 20 minutes to obtain the milled paste below, referenced SF2.

The alcohol (PPG) and PTFE powder are pre-dispersed at very high speed with an ultra-turax system before incorporation into a mixture such as:

| | | |
|---|---|---|
| Propylene glycol | 23.8 | g |
| PTFE Powder | 11.9 | g |
| FEP powder | 3.97 | g |
| NFM | 17.33 | g |
| Genapol X089 | 9.52 | g |
| Tego foamex K7 | 1.75 | g |
| PEEK, VICOTE 704 | 23.8 | g |
| Black Pigment 100 | 7.93 | g |
| TOTAL | 100 | g |

### Composition of the Sublayer SCD1 of Example 1

The final step is carried out in a Rayneri type disperser to obtain the hard sublayer below:

| | | |
|---|---|---|
| SF2 | 58.5 | g |
| Acrylic resin, Rohagit SD 15 | 7 | g |
| SIKA400 fillers | 11.6 | g |
| Water | 22.9 | g |
| TOTAL | 100 | g |

The properties of the sublayer SCD1 of Example 1 thus obtained are as follows:
The final mass ratio of the polymer resin mixture is as follows:

PEEK/Filler/PTFE/FEP/Acrylic resin/Pigment: 30/25/15/5/15/10:
Theoretical dry extract: 46.4%
Viscosity measured in AFNOR CA6 Cup: 50 sec

The thickness of this layer SCD1 of Example 1 is comprised between 50 μm to 100 μm, preferably 40 μm to 60 μm.

The substrate and the continuous sublayer as described above are coated with a multi-layer non-stick coating composed of a Mid-coat (6-8 μm) which is dried for 4 minutes at 100° C. and a finish (14-18 μm). The whole being finally heated at 430° C. for 11 minutes, that is to say that the method only comprises a single sintering step at T° C.>400° C., after the deposition of the various layers. The compositions are as follows:

### Composition of the Mid-Coat (MD)

| | | |
|---|---|---|
| PTFE dispersion (60% dry) | 375.2 | g |
| PFA dispersion (50% dry) | 103.7 | g |
| Lampblack (25% dry) | 47.7 | g |
| Colloidal silica (30% dry) | 33.4 | g |
| SF1 | 189.8 | g |
| Spreading agents (surfactants) | 97.3 | g |
| Water | 134.3 | g |
| Propylene glycol | 18.6 | g |
| TOTAL | 1000.0 | g |

### Finishing Composition (F)

| | | |
|---|---|---|
| PTFE dispersion (60% dry) | 80.60 | g |
| PFA dispersion (50% dry) | 0.50 | g |
| Lampblack (25% dry) | 0.02 | g |
| Spreading agents (surfactants) | 2.23 | g |
| Water | 8.02 | g |
| Xylene | 6.50 | g |
| Acrylic Resin Modarez PW336 | 0.60 | g |
| Triethanolamine | 2.22 | g |
| Metallic decor sequins | 0.20 | g |
| Propylene glycol | 1.11 | g |
| TOTAL | 100.00 | g |

### Example 2

On a shaped aluminum disk (30 cm in diameter), previously degreased and sanded to obtain a roughness of 4 to 7 μm (Ra), a continuous layer SCD2 of example 2 is deposited as described below.

### Principle of Operation of the Jar Mill (Mechanical Milling)

### Principle

Ball milling consists of loading a jar with the sample to be milled and so-called milling balls and rotating the jar around its axis at a certain speed. The rotation of the jar is generally carried out using a roller machine. The sample can be milled in dry form or dispersed in a suitable solvent (for example in water, in alcohol or in a solvent). The dispersion may also contain certain adjuvants (such as a dispersant or anti-foam agent).

Preparation of a semi-finished composition SF3 carried out in a ball mill for 20 minutes to obtain the milled paste below, referenced SF3.

| | | |
|---|---|---|
| Propylene glycol | 30.99 | g |
| NEM | 7.75 | g |
| Genapol X089 | 6.2 | g |
| Tego foamex K7 | 3.41 | g |
| PEEK | 46.49 | g |
| PTFE Powder | 5.16 | g |
| TOTAL | 100 | g |

### Composition of the Sublayer SCD2 of Example 2

The final step is carried out in a Rayneri type disperser to obtain the hard sublayer below:

| | | |
|---|---|---|
| SF3 | 88.85 | g |
| Water | 11.5 | g |
| TOTAL | 100 | g |

The properties of the SCD2 sublayer of Example 2 thus obtained are as follows:
The final mass ratio of the polymer resin mixture is as follows: PEEK/PTFE: 90/10
Theoretical dry extract: 45.7%
Viscosity measured in AFNOR CA6 Cup: 25 sec

The thickness of this layer SCD2 of Example 2 is comprised between 50 μm to 100 μm, preferably 40 μm to 60 μm.

The substrate and the continuous sublayer as described above are coated with a multi-layer non-stick coating composed of a Mid-coat (6-8 μm) which is dried for 4 minutes at 100° C. and a finish (14-18 μm). The whole being finally heated at 430° C. for 11 minutes, that is to say that the method only comprises a single sintering step at T° C.>400° C., after the deposition of the various layers.

The formulas for the mid-coat and the finish are given above.

### Example 3

On a shaped aluminum disk (30 cm in diameter), previously degreased and sanded to obtain a roughness of 4 to 7 μm (Ra), a continuous layer of Example 3 is deposited as described below.

### Composition of the Sublayer SCD3 of Example 3

The final step is carried out in a Rayneri type disperser to obtain the hard sublayer below:

| | | |
|---|---|---|
| Vicote F815 | 92 | g |
| NFM | 4 | g |
| Water | 4 | g |
| TOTAL | 100 | g |

The properties of the sublayer of Example 3 thus obtained are as follows:
The final mass ratio of the polymer resin mixture is as follows: PEEK/[PTFE+PFA]: 70/30
Theoretical dry extract: 27.6%
Viscosity measured in AFNOR CA4 Cup: 27 sec

The thickness of the sublayer SCD3 of Example 3 is comprised between 50 μm to 100 μm, preferably 50 μm to 60 μm

The substrate and the continuous sublayer as described above are dried for between 4 to 10 minutes at 100-110° C. Then the whole is finally heated and sintered at 430° C. for 11 minutes before being cooled, that is to say that the method only comprises a single sintering step at T° C.>400° C.

In this example, the sublayer constitutes the coating. It is not coated with other layers.

### Example 4

On a shaped aluminum disk (30 cm in diameter), previously degreased and sanded to obtain a roughness of 4 to 7 μm (Ra), a continuous layer SCD4 (SCD=tie sublayer) of Example 4 as described below.

### Principle of Operation of the Jar Mill (Mechanical Milling)

### Principle

Ball milling consists of loading a jar with the sample to be milled and so-called milling balls and rotating the jar around its axis at a certain speed. The rotation of the jar is generally carried out using a roller machine. The sample can be milled in dry form or dispersed in a suitable solvent (for example in water, in alcohol or in a solvent). The dispersion may also contain certain adjuvants (such as a dispersant or anti-foam agent).

Preparation of a semi-finished composition SF4 carried out in a ball mill for 20 minutes to obtain the milled paste below, referenced SF4.

The alcohol (PPG) and PTFE powder are pre-dispersed at very high speed with an ultra-turax system before incorporation into a mixture such as:

| | | |
|---|---|---|
| Propylene glycol | 22.50 | g |
| PTFE Powder | 20.70 | g |
| NEM | 22.50 | g |
| Genapol X089 | 4.50 | g |
| Tego foamex K7 | 0.80 | g |
| PEEK Vicote 704 | 13.10 | g |
| PES | 15.90 | g |
| TOTAL | 100 | g |

### Composition of the Sublayer SCD4 of Example 4

The final step is carried out in a Rayneri type disperser to obtain the tie sublayer below:

| | | |
|---|---|---|
| SF1 | 13.0 | g |
| SF4 | 58.9 | g |
| water | 17.9 | g |
| SIKA400 fillers | 10.2 | g |
| TOTAL | 100 | g |

The properties of the sublayer SCD4 of Example 4 thus obtained are as follows:
The final mass ratio of the polymer resin mixture is as follows: PEEK/PAI/PES/Filler/PTFE: 19/3/23/25/30
Theoretical dry extract: 40.7%
Viscosity measured in AFNOR CA6 Cup: 50 sec

The thickness of this layer SCD4 of Example 4 is comprised between 50 μm to 100 μm, preferably 40 μm to 60 μm.

The substrate and the continuous sublayer as described above are coated with a multi-layer non-stick coating composed of a Mid-coat (6-8 μm) which is dried for 4 minutes at 100° C. and a finish (14-18 μm). The whole being finally heated at 430° C. for 11 minutes, that is to say that the method only comprises a single sintering step at T° C.>400° C., after the deposition of the various layers.

### Finishing Composition (F)

| | |
|---|---|
| PTFE dispersion (60% dry) | 80.42 g |
| PFA dispersion (50% dry) | 0.50 g |
| Lampblack (25% dry) | 0.2 g |
| Spreading agents (surfactants) | 2.23 g |
| Water | 8.02 g |
| Xylene | 6.50 g |
| Acrylic Resin Modarez PW336 | 0.60 g |
| Triethanolamine | 2.22 g |
| Metallic decor sequins | 0.20 g |
| Propylene glycol | 1.11 g |
| TOTAL | 100.00 g |

### Example 5

On a shaped aluminum disk (30 cm in diameter), previously degreased and sanded to obtain a roughness of 4 to 7 μm (Ra), a continuous layer SCD5 of Example 5 is deposited as described below.

### Principle of Operation of the Jar Mill (Mechanical Milling)

### Principle

Ball milling consists of loading a jar with the sample to be milled and so-called milling balls and rotating the jar around its axis at a certain speed. The rotation of the jar is generally carried out using a roller machine. The sample can be milled in dry form or dispersed in a suitable solvent (for example in water, in alcohol or in a solvent). The dispersion may also contain certain adjuvants (such as a dispersant or anti-foam agent).

Preparation of a semi-finished composition SF5 carried out in a ball mill for 20 minutes to obtain the milled paste below, referenced SF5.

| | |
|---|---|
| Propylene glycol | 23.6 g |
| NFM | 4.7 g |
| Genapol X089 | 1.9 g |
| Tego foamex K7 | 14.9 g |
| Black Pigment 100 | 14.2 g |
| PEEK Vicote 704 | 17.1 g |
| PES | |
| TOTAL | 100 g |

### Composition of the Sublayer SCD5 of Example 5

The final step is carried out in a Rayneri type disperser to obtain the tie sublayer below:

| | |
|---|---|
| SF1 | 10.8 g |
| SF5 | 55.4 g |
| water | 19.3 g |
| SIKA400 fillers | 12.4 g |
| Acrylic resin MODAREZ SD15 | 2.1 g |
| TOTAL | 100 g |

The properties of the SCD5 sublayer of Example 5 thus obtained are as follows:
The final mass ratio of the polymer resin mixture is as follows: PEEK/PAI/PES/Filler/Acryl. resin/Pigment: 19/3/23/30/5/20
Theoretical dry extract: 41.1%
Viscosity measured in AFNOR CA6 Cup: 45 sec

The thickness of this layer SCD5 of Example 5 is comprised between 50 μm to 100 μm, preferably 40 μm to 60 μm.

The substrate and the continuous sublayer as described above are coated with a multi-layer non-stick coating composed of a Mid-coat (6-8 μm) which is dried for 4 minutes at 100° C. and a finish (14-18 μm). The whole being finally heated at 430° C. for 11 minutes, that is to say that the method only comprises a single sintering step at T° C.>400° C., after the deposition of the various layers.

The formulas for the mid-coat and the finish are given above.

### Example 6

On a shaped aluminum disk (30 cm in diameter), previously degreased and sanded to obtain a roughness of 4 to 7 μm (Ra), a continuous layer SCD6 of Example 6 is deposited as described below.

### Principle of Operation of the Jar Mill (Mechanical Milling)

### Principle

Ball milling consists of loading a jar with the sample to be milled and so-called milling balls and rotating the jar around its axis at a certain speed. The rotation of the jar is generally carried out using a roller machine. The sample can be milled in dry form or dispersed in a suitable solvent (for example in water, in alcohol or in a solvent). The dispersion may also contain certain adjuvants (such as a dispersant or anti-foam agent).

Preparation of a semi-finished composition SF6 carried out in a ball mill for 20 minutes to obtain the milled paste below, referenced SF6.

The alcohol (PPG) and the PTFE and FEP powders are pre-dispersed at very high speed with an ultra-turax system before incorporation into a mixture such as:

| | |
|---|---|
| Propylene glycol | 26.0 g |
| NFM | 17.3 g |
| Genapol X089 | 5.2 g |
| Tego foamex K7 | 1.4 g |
| Black Pigment 100 | 6.1 g |
| PTFE | 18.3 g |
| PEEK Vicote 704 | 10.4 g |
| PES | 15.3 g |
| TOTAL | 100 g |

### Composition of the Sublayer SCD6 of Example 6

The final step is carried out in a Rayneri type disperser to obtain the tie sublayer below:

| | |
|---|---|
| SF1 | 11.7 g |
| SF6 | 67.4 g |
| water | 14.7 g |
| SIKA400 fillers | 6.2 g |
| TOTAL | 100 g |

The properties of the sublayer SCD6 of Example 6 thus obtained are as follows:
The final mass ratio of the polymer resin mixture is as follows: PEEK/PAI/PES/Filler/PTFE/Pigment: 17/3/25/15/30/10
Theoretical dry extract: 41.1%
Viscosity measured in AFNOR CA6 Cup: 2.10 min

The thickness of this layer SCD6 of Example 6 is comprised between 50 μm to 100 μm, preferably 40 μm to 60 μm.

The substrate and the continuous sublayer as described above are coated with a multi-layer non-stick coating composed of a Mid-coat (6-8 μm) which is dried for 4 minutes at 100° C. and a finish (14-18 μm). The whole being finally heated at 430° C. for 11 minutes, that is to say that the method only comprises a single sintering step at T° C.>400° C., after the deposition of the various layers.

The formulas for the mid-coat and the finish are given above.

### Example 7

On a shaped aluminum disk (30 cm in diameter), previously degreased and sanded to obtain a roughness of 4 to 7 μm (Ra), a continuous layer SCD7 of example 7 is deposited as described below.

### Principle of Operation of the Jar Mill (Mechanical Milling)

### Principle

Ball milling consists of loading a jar with the sample to be milled and so-called milling balls and rotating the jar around its axis at a certain speed. The rotation of the jar is generally carried out using a roller machine. The sample can be milled in dry form or dispersed in a suitable solvent (for example in water, in alcohol or in a solvent). The dispersion may also contain certain adjuvants (such as a dispersant or anti-foam agent).

Preparation of a semi-finished composition SF7 carried out in a ball mill for 20 minutes to obtain the milled paste below, referenced SF7.

| | |
|---|---|
| Propylene glycol | 21.4 g |
| NFM | 21.4 g |
| Genapol X089 | 8.0 g |
| Tego foamex K7 | 1.5 g |
| Black Pigment 100 | 15.9 g |
| PEEK VICOTE 704 | 12.9 g |
| PES | 18.9 g |
| TOTAL | 100 g |

### Composition of the Sublayer SCD7 of Example 7

The final step is carried out in a Rayneri type disperser to obtain the tie sublayer below:

| | |
|---|---|
| SF1 | 11.7 g |
| SF7 | 56.3 g |
| water | 17.1 g |
| SIKA400 fillers | 12.8 g |
| Acrylic resin MODAREZ SD15 | 2.1 g |
| TOTAL | 100 g |

The properties of the sublayer SCD7 of Example 7 thus obtained are as follows:
The final mass ratio of the polymer resin mixture is as follows: PEEK/PAI/PES/Filler/Acryl. resin/Pigment: 17/2/25/30/5/21
Theoretical dry extract: 42.9%
Viscosity measured in AFNOR CA6 Cup: 55 sec

The thickness of this layer SCD7 of Example 7 is comprised between 50 μm to 100 μm, preferably 40 μm to 60 μm.

The substrate and the continuous sublayer as described above are coated with a multi-layer non-stick coating composed of a Mid-coat (6-8 μm) which is dried for 4 minutes at 100° C. and a finish (14-18 μm). The whole being finally heated at 430° C. for 11 minutes, that is to say that the method only comprises a single sintering step at T° C.>400° C., after the deposition of the various layers.

The formulas for the mid-coat and the finish are given above.

### Example 8

On a shaped aluminum disk (30 cm in diameter), previously degreased and sanded to obtain a roughness of 4 to 7 μm (Ra), a continuous layer SCD8 of Example 8 is deposited as described below.

### Principle of Operation of the Jar Mill (Mechanical Milling)

### Principle

Ball milling consists of loading a jar with the sample to be milled and so-called milling balls and rotating the jar around its axis at a certain speed. The rotation of the jar is generally carried out using a roller machine. The sample can be milled in dry form or dispersed in a suitable solvent (for example in water, in alcohol or in a solvent). The dispersion may also contain certain adjuvants (such as a dispersant or anti-foam agent).

Preparation of a semi-finished composition SF8 carried out in a ball mill for 20 minutes to obtain the milled paste below, referenced SF8.

The alcohol (PPG) and PTFE powder are pre-dispersed at very high speed with an ultra-turax system before incorporation into a mixture such as:

| | |
|---|---|
| Propylene glycol | 23.6 g |
| PTFE powder | 15.6 g |
| FEP powder | 3.1 g |
| NFM | 19.9 g |
| Genapol X089 | 9.9 g |
| Tego foamex K7 | 1.6 g |
| PEEK Vicote 704 | 11.9 g |
| PES | 14.4 g |
| TOTAL | 100 g |

### Composition of the Sublayer SCD8 of Example 8

The final step is carried out in a Rayneri type disperser to obtain the tie sublayer below:

| | |
|---|---|
| SF1 | 10.9 g |
| SF8 | 65.9 g |
| water | 12.9 g |
| SIKA400 fillers | 10.3 g |
| TOTAL | 100 g |

The properties of the sublayer SCD8 of Example 8 thus obtained are as follows:
The final mass ratio of the polymer resin mixture is as follows: PEEK/PAI/PES/Filler/PTFE/FEP: 19/3/23/25/25/5
Theoretical dry extract: 41.0%
Viscosity measured in AFNOR CA6 Cup: 1 min 50

The thickness of this layer SCD8 of Example 8 is comprised between 50 μm to 100 μm, preferably 40 μm to 60 μm.

The substrate and the continuous sublayer as described above are coated with a multi-layer non-stick coating composed of a Mid-coat (6-8 μm) which is dried for 4 minutes at 100° C. and a finish (14-18 μm). The whole being finally heated at 430° C. for 11 minutes, that is to say that the method only comprises a single sintering step at T° C.>400° C., after the deposition of the various layers.

The formulas for the mid-coat and the finish are given above.

### Example 9

On a shaped aluminum disk (30 cm in diameter), previously degreased and sanded to obtain a roughness of 4 to 7 μm (Ra), a continuous layer SCD9 of Example 9 is deposited as described below.

Preparation of a semi-finished composition SF9 carried out in a ball mill for 20 minutes to obtain the milled paste below, referenced SF9.

| | |
|---|---|
| Propylene glycol | 20.1 g |
| NFM | 20.1 g |
| Genapol X089 | 6.7 g |
| Tego foamex K7 | 2.0 g |
| PEEK VICOTE 704 | 40.3 g |
| PES | 10.8 g |
| TOTAL | 100 g |

### Composition of the Sublayer SCD9 of Example 9

The final step is carried out in a Rayneri type disperser to obtain the hard sublayer below:

| | |
|---|---|
| SF1 | 18.5 g |
| SF9 | 72.1 g |
| Water | 9.4 g |
| TOTAL | 100 g |

The properties of the sublayer SCD9 of Example 9 thus obtained are as follows:
The final mass ratio of the polymer resin mixture is as follows:
PEEK/PAI/PES: 75/5/20
Theoretical dry extract: 38.6%
Viscosity measured in AFNOR CA6 Cup: 1 min 40 sec

The thickness of this layer SCD9 of Example 9 is comprised between 50 μm to 100 μm, preferably 40 μm to 60 μm.

The substrate and the continuous sublayer as described above are coated with a multi-layer non-stick coating composed of a Mid-coat (6-8 μm) which is dried for 4 minutes at 100° C. and a finish (14-18 μm). The whole being finally heated at 430° C. for 11 minutes, that is to say that the method only comprises a single sintering step at T° C.>400° C., after the deposition of the various layers.

The formulas for the mid-coat and the finish are given above.

### Example 10

On a shaped aluminum disk (30 cm in diameter), previously degreased and sanded to obtain a roughness of 4 to 7 μm (Ra), a continuous layer SCD10 of Example 10 is deposited as described below.

Preparation of a semi-finished composition SF10 carried out in a ball mill for 20 minutes to obtain the milled paste below, referenced SF10.

The alcohol (PPG) and PTFE powders are pre-dispersed at very high speed with an ultra-turax system before incorporation into a mixture such as:

| | |
|---|---|
| Propylene glycol | 20.3 g |
| NFM | 20.3 g |
| Genapol X089 | 8.8 g |
| Tego foamex K7 | 1.5 g |
| PEEK VICOTE 704 | 23.7 g |
| PES | 11.3 g |
| Black pigment 100 | 2.8 g |
| PTFE | 11.3 g |
| TOTAL | 100 g |

### Composition of the Sublayer SCD10 of Example 10

The final step is carried out in a Rayneri type disperser to obtain the hard sublayer below:

| | |
|---|---|
| SF1 | 11.8 g |
| SF10 | 71.7 g |
| Water | 12.5 g |
| SIKA 400 fillers | 4.0 g |
| TOTAL | 100 g |

The properties of the sublayer SCD10 of Example 10 thus obtained are as follows:
The final mass ratio of the polymer resin mixture is as follows: PEEK/PAI/PES/Filler/PTFE/Pigment: 42/3/20/10/20/5
Theoretical dry extract: 40.3%
Viscosity measured in AFNOR CA6 Cup: 2 min 40 sec

The thickness of this layer SCD10 of Example 10 is comprised between 50 μm to 100 μm, preferably 40 μm to 60 μm.

The substrate and the continuous sublayer as described above are coated with a multi-layer non-stick coating composed of a Mid-coat (6-8 μm) which is dried for 4 minutes at 100° C. and a finish (14-18 μm). The whole being finally heated at 430° C. for 11 minutes, that is to say that the method only comprises a single sintering step at T° C.>400° C., after the deposition of the various layers.

The formulas for the mid-coat and the finish are given above.

### Counterexample 1

On a shaped aluminum disk (30 cm in diameter), previously degreased and sanded to obtain a roughness of 4 to 7 μm (Ra), a continuous layer SCD2 of example 2 is deposited.

The thickness of this layer SCD2 of Example 2 is comprised between 50 μm to 100 μm, preferably 40 μm to 60 μm.

This sublayer is heated to 430° C. for 11 minutes then cooled to 25-30° C. for coating the following fluorinated layers:

A non-stick coating composed of a Mid-coat (6-8 μm) which is dried for 4 minutes at 100° C. and a finish (14-18 μm). The whole being finally heated to 430° C. for 11 minutes. This method therefore comprises two sintering steps.

The formulas for the mid-coat and the finish are given above.

### Counterexample 2

On a shaped aluminum disk (30 cm in diameter), previously degreased and sanded to obtain a roughness of 4 to 7 μm (Ra), a continuous layer SCD11 is deposited.

### Principle of Operation of the Jar Mill (Mechanical Milling)

### Principle

Ball milling consists of loading a jar with the sample to be milled and so-called milling balls and rotating the jar around its axis at a certain speed. The rotation of the jar is generally carried out using a roller machine. The sample can be milled in dry form or dispersed in a suitable solvent (for example in water, in alcohol or in a solvent). The dispersion may also contain certain adjuvants (such as a dispersant or anti-foam agent).

Preparation of a semi-finished composition SF11 carried out in a ball mill for 20 minutes to obtain the milled paste below, referenced SF11.

| | |
|---|---|
| Propylene glycol | 32.68 g |
| NFM | 8.17 g |
| Genapol X089 | 6.54 g |
| Tego foamex K7 | 3.59 g |
| PEEK VICOTE704 | 49.02 g |
| TOTAL | 100 g |

Composition of the sublayer SCD11 is carried out in a Rayneri type disperser to obtain the hard sublayer below:

| | |
|---|---|
| SF11 | 88.5 g |
| Water | 11.5 g |
| TOTAL | 100 g |

The properties of the sublayer SCD11 thus obtained are as follows:
The final mass ratio of the polymer resin mixture is as follows: PEEK 100%
Theoretical dry extract: 43.4%
Viscosity measured in AFNOR CA6 Cup: 30 sec

The thickness of this layer SCD11 of Counter-example 2 is comprised between 50 μm to 100 μm, preferably 40 μm to 60 μm.

The substrate and the continuous sublayer as described above are coated with a multi-layer non-stick coating composed of a Mid-coat (6-8 μm) which is dried for 4 minutes at 100° C. and a finish (14-18 μm). The whole being finally heated at 430° C. for 11 minutes.

The formulas for the mid-coat and the finish are given above.

### 3) Advantages Provided

The table below clearly shows the advantage provided by the use of a sublayer based on a mixture of thermostable polymer resins based on PEEK with or without the presence of:
Fluoride resins
Fillers
Acrylic resin
Pigment

| | | | | | | Hot Blade Test | | |
|---|---|---|---|---|---|---|---|---|
| | | | Thickness | | | at 180° C. | | |
| | | Number of | of the SCD | | | AA = 0 | | Resistance |
| | | sintering | sublayer | “Non-Stick” | Adhesion | (non-stick) | Wear | to |
| Coating | SCD Composition | cycles | [μm] | Performance | Test | Metal Scratch | indicator | corrosion |
| Example 1 | PEEK/Filler/PTFE/FEP/ | 1 | SCD1 | OK | OK | OK Compliant > 2 h | YES | OK |
| SCD1 of example | Acryl. resin/Pigment: | | 40 μm to | | | no scratches on the | | |
| 1 + MD + F | 30/25/15/5/15/10 | | 60 μm | | | metal 5 h 30 | | |
| | Theoretical dry | | | | | | | |
| | extract: 46.4% | | | | | | | |
| Example 2 | PEEK/PTFE: 90/10 | 1 | SCD2 | OK | OK | OK Compliant > 2 h | NO | OK |
| SCD2 of example | Theoretical dry | | 40 μm to | | | no scratches on the | | |
| 2 + MD + F | extract: 45.7% | | 60 μm | | | metal 4 h | | |
| Example 3 | PEEK/[PTFE + | 1 | Vicote F815 | OK | OK | OK Compliant > 2 h | NO | OK |
| SCD3 of example 3 | PFA]: 70/30 | | 40 μm to | | | no scratches on the | | |
| | Theoretical dry | | 60 μm | | | metal 4 h | | |
| | extract: 27.6% | | | | | | | |
| Example 4 | PEEK/PAI/PES/Filler/ | 1 | SCD4 | OK | OK | OK Compliant > 2 h | NO | OK |
| SCD4 of example | PTFE: 19/3/23/25/30 | | 40 μm to | | | no scratches on the | | |
| 4 + MD + F | Theoretical dry | | 60 μm | | | metal 4 h | | |
| | extract: 40.7% | | | | | | | |
| Example 5 | PEEK/PAI/PES/Filler/ | 1 | SCD5 | OK | OK | OK Compliant > 2 h | YES | OK |
| SCD5 of example | Acryl. resin/Pigment: | | 40 μm to | | | no scratches on the | | |
| 5 + MD + F + | 19/3/23/30/5/20 | | 60 μm | | | metal 4 h | | |
| MD + F | Theoretical dry | | | | | | | |
| | extract: 41.1% | | | | | | | |
| Example 6 | PEEK/PAI/PES/Filler/ | 1 | SCD6 | OK | OK | OK Compliant > 2 h | YES | OK |
| SCD6 of example | PTFE/Pigment: | | 40 μm to | | | no scratches on the | | |
| 6 + MD + F | 17/3/25/15/30/10 | | 60 μm | | | metal 5 h | | |
| | Theoretical dry | | | | | | | |
| | extract: 41.1% | | | | | | | |
| Example 7 | PEEK/PAI/PES/Filler/ | 1 | SCD7 | OK | OK | OK Compliant > 2 h | YES | OK |
| SCD7 of example | Acryl. resin/Pigment: | | 40 μm to | | | no scratches on the | | |
| 7 + MD + F | 17/2/25/30/5/21 | | 60 μm | | | metal 3 h 30 | | |
| | Theoretical dry | | | | | | | |
| | extract: 42.9% | | | | | | | |
| Example 8 | PEEK/PAI/PES/Filler/PTFE/ | 1 | SCD8 | OK | OK | OK Compliant > 2 h | NO | OK |
| SCD8 of example | FEP: 19/3/23/25/25/5 | | 40 μm to | | | no scratches on the | | |
| 8 + MD + F | Theoretical dry | | 60 μm | | | metal 4 h | | |
| | extract: 41.0% | | | | | | | |
| Example 9 | PEEK/PAI/PES: 75/5/20 | 1 | SCD9 | OK | OK | OK Compliant > 2 h | NO | OK |
| SCD9 of example | Theoretical dry | | 40 μm to | | | no scratches on the | | |
| 9 + MD + F | extract: 38.6% | | 60 μm | | | metal 4 h | | |
| Example 10 | PEEK/PAI/PES/Filler/ | 1 | SCD10 | OK | OK | OK Compliant > 2 h | YES | OK |
| SCD10 of example | PTFE/Pigment: | | 40 μm to | | | no scratches on the | | |
| 10 + MD + F | 42/3/20/10/20/5 | | 60 μm | | | metal 4 h | | |
| | Theoretical dry | | | | | | | |
| | extract: 40.3% | | | | | | | |
| Counterexample 1 | PEEK/PTFE: 90/10 | 2 | SCD2 | OK | NOK | NOT Compliant | NO | NOK |
| SCD2 of example | Theoretical dry | | 40 μm to | | | Scratches on the | | |
| 2 + MD + F | extract: 45.7% | | 60 μm | | | metal 2 h | | |
| Counterexample 2 | PEEK: 100 | 1 | SCD11 | OK | NOK | NOT Compliant | NO | NOK |
| SCD11 of | Theoretical dry | | 40 μm to | | | Scratches on the | | |
| counterexample | extract: 43.4% | | 60 μm | | | metal 15 min | | |
| 2 + MD + F | | | | | | | | |

The anti-adhesiveness of the complete coating with the upper layers based on fluorinated resins is good.

The appearance of the scratch highlighted by the tests used (hot blade at 180° C.) is largely postponed or even non-existent for a configuration where the thickness of the sublayer is comprised between 50 μm and 100 μm, preferably between 40 μm and 60 μm.

This coating is obtained in a single sintering condition at 400-430° C. for 11 minutes while maintaining excellent adhesion performance to the metal substrate and inter-layer adhesion.

1-18. (canceled)

19. A method for applying a non-stick coating to a metal support comprising the following steps:
i. Depositing on the metal support one or more continuous layers of a tie sublayer comprising one or more polymers selected from the group consisting of polyaryletherketones (PAEK), polyethyleneimines (PEI), polyimides (PI), polyamide imides (PAI) and polybenzymidazole (PBI) in an amount of 20 to 95% by weight of the total weight of said sublayer,
wherein said method comprises, in overall, only a single sintering step at T° C.>400° C., after the deposition of the various layers.

20. The method according to claim 19, comprising the following step after step i. before the sintering step:
ii. Depositing one or more layers of a non-stick coating based on one or more fluorocarbon resin(s).

21. The method according to claim 19, comprising the following step after step i. before the sintering step:
ii. Depositing two layers of a non-stick coating based on one or more fluorocarbon resin(s).

22. The method according to claim 19, wherein said tie sublayer comprises one or more aromatic polymer resins selected from the group consisting of phenylene polysulfides (PPS) and polyethersulfones (PES).

23. The method according to claim 19, wherein said tie sublayer comprises one or more polyethersulfone (PES).

24. The method according to claim 19, wherein the polyaryletherketone(s) (PAEK) is (are) selected from the group consisting of: polyetherketones (PEK), polyetheretherketones (PEEK), polyetherketoneketones (PEKK), polyetheretherketoneketones (PEEKK) and polyetherketoneetherketoneketones (PEKEKK).

25. The method according to claim 19, wherein said tie sublayer comprises one or more fluorocarbon resin(s).

26. The method according to claim 19, wherein the fluorocarbon resin(s) is/are selected from the group consisting of: polytetrafluoroethylene (PTFE), the copolymer of tetrafluoroethylene and perfluoropropylvinyl ether (PFA), the copolymer of tetrafluoroethylene and hexafluoropropylene (FEP) and mixtures thereof.

27. The method according to claim 19, wherein said tie sublayer further comprises inorganic reinforcing fillers, preferably selected from the group consisting of metal oxides, carbides, nitrides, preferably alumina, silicon carbides or fumed silica.

28. The method according to claim 19, wherein said tie sublayer further comprises inorganic reinforcing fillers selected from the group consisting of metal oxides, carbides, nitrides.

29. The method according to claim 19, wherein said tie sublayer further comprises inorganic reinforcing fillers selected from the group consisting of alumina, silicon carbides and fumed silica.

30. The method according to claim 19, wherein said tie sublayer further comprises one or more solvents, which are preferably polar aprotic.

31. The method according to claim 19, wherein said tie sublayer further comprises one or more surfactants.

32. The method according to claim 19, wherein said tie sublayer further comprises one or more anti-foam agents.

33. The method according to claim 19, wherein said tie sublayer further comprises one or more pigments.

34. The method according to claim 19, wherein the tie sublayer presents a thickness comprised between 10 and 100 μm.

35. The method according to claim 19, wherein the tie sublayer presents a thickness comprised between 20 and 80 μm.

36. The method according to claim 19, wherein said metal support is the cap of a culinary article and said coating is applied to the surface in contact with the food.

37. The method according to claim 36, wherein said culinary article is a frying pan, a wok or a pot.

38. The method according to claim 19, wherein said metal support is a mono-layer support made of aluminum or aluminum alloy, cast aluminum, stainless steel, cast steel or copper, or a multi-layer support comprising from the outside to the inside the following layers ferritic stainless steel/aluminum/austenitic stainless steel or stainless steel/aluminum/copper/aluminum/austenitic stainless steel, or a foundry aluminum cap, aluminum or aluminum alloys lined with a stainless steel exterior base.

39. The method according to claim 19, wherein the tie sublayer is deposited by spray, by coating, by screen printing or by roller.

40. The method according to claim 19, wherein the sintering temperature is comprised between 400° C. and 440° C.

41. A method for manufacturing a culinary article comprising the following steps:
i. a step of providing a metal support, comprising two opposite faces,
ii. a step of shaping said support to give it the shape of a cap, which comprises a bottom and a side wall rising from the bottom, and thus define a concave internal face adapted to receive food and a convex external face, said step ii) being carried out either before step iii) of producing the tie sublayer, or after step iv) of producing the non-stick coating,
iii. Depositing, on the internal face or on the bottom of the support, one or more continuous layers of the tie sublayer as defined in claim 1,
iv. Optionally depositing one or more layers of a non-stick coating based on fluorocarbon resins, on said tie sublayer deposited in step (iii),
wherein the method comprises in overall only a single sintering step (v) at T° C.>400° C., after the deposition of the various layers.

42. The method according to claim 41, wherein step (ii) further comprises a (ii′) step of treating the internal face of the support, to obtain a treated internal face favoring the adhesion of a sublayer on the support.
